(19) United States
(12) Patent Application Publication
(10) Pub. No.: US 2010/0092921 A1
(43) Pub. Date: Apr. 15, 2010

(54) DENTAL PIN REMOVAL SYSTEM AND METHODS

(76) Inventor: Ronald E. Huffman, Oro Valley, AZ (US)

Correspondence Address: HOLLAND & HART LLP, 60 E. South Temple, Suite 2000, P.O. Box 11583, Salt Lake City, UT, 84110, US

(21) Appl. No.: 12/579,562

(22) Filed: Oct. 15, 2009

Related U.S. Application Data
(60) Provisional application No. 61/105,743, filed on Oct. 15, 2008.

(51) Int. Cl. A61C 13/34; B23P 19/04

(52) U.S. Cl. 433/213; 29/256; 29/426.5

(57) ABSTRACT

A pin removal system is configured to remove a dowel pin from a dental model base. The system includes first and second members. The first member is configured to releasably mount to the dental model base, and the second member is movable relative to the first member and into engagement with the pin to move the pin relative to the dental model base. The dowel pin can be secured to a model of at least one tooth that is mounted to the dental model base.

### CROSS-REFERENCE TO RELATED APPLICATION

This application claims the benefit of the filing date of U.S. Provisional Application No. 61/105,743, filed Oct. 15, 2008, and entitled DENTAL PIN REMOVAL SYSTEM AND METHODS, the disclosure of which is incorporated, in its entirety, by this reference.

### TECHNICAL FIELD

The present disclosure is directed to dental modeling systems and methods, and more particularly relates to removal of a pin member in a dental modeling system.

### BACKGROUND

The present disclosure relates generally to dental modeling systems and more particularly to systems and methods for removing dental pins from such dental modeling systems.

Creating a dental model from a mold of a person's teeth is a well-known practice. Dental models are used for dental work such as, for example, dental prosthesis (e.g., crowns and bridges), and orthodontics. A mold of a person's teeth is typically formed when a patient bites into a pliant casting material that cures to create a mold cavity defining a negative impression of the person's teeth and gums. The mold can represent all or any portion of the person's teeth and gum line. When forming a dental model, a castable material is poured into the negative impression of the mold and the cured castable material results in a stone replica or dental model of the patient's teeth and gums.

To facilitate prosthesis development, the replica of the damaged tooth or teeth is severed from the remainder of the dental model. Severability is achieved by positioning the knurled end of a dowel pin in the uncured stone material in correspondence with the damaged tooth or teeth. The dowel pin or pins must be carefully aligned and held in position. An opposing end of the dowel pins protruding from the dental model are mounted in the dental model base. This opposing end of the dowel pins can be tapered to facilitate removal of the dowel pins from the dental model base.

Once the damaged tooth model is removed from the rest of the dental model, the prosthesis can be fitted and adjusted without the spatial limitations encountered when the damaged tooth model is joined to the full dental model. After the prosthesis is made and attached to the dental model segment, the dowel pin is reinserted in the aperture in the dental model base which guides the dental model segment to its position in the dental model.

In some instances, the dowel pins are tightly fit in the dental model base. Removal of such tightly fit dowel pins can be difficult. Attempts to remove the dowel pins by application of force to the dental model associated with the pin risks damage to the dental model.

### SUMMARY

One aspect of the present disclosure relates to a pin removal system that is configured to remove a pin from a dental model base. The system includes first and second members, wherein the first member is configured to releasably mount to the dental model base, and the second member is movable relative to the first member and into engagement with the pin to move the pin relative to the dental model base.

Another aspect of the present disclosure relates to a method of removing a pin from a dental model base with a pin removal system. The method includes releaseably securing the pin removal system to the dental model base, and engaging the pin with the pin removal system to move the pin relative to the dental model base. Releaseably securing the pin removal system to the dental model base can include inserting a portion of the dental model base into the pin removal system.

A further aspect of the present disclosure relates to a dental modeling assembly that includes a dental model base, a plurality of pins, and a pin removal system. The dental model base includes a model support surface configured to support a cast stone model of a person's teeth. The plurality of pins are configured for mounting to the dental model base and at least partially extending into the cast stone model mounted to the dental model base. The pin removal system is configured to releaseably mount to the dental model base and engage at least one of the plurality of pins to move the at least one plurality of pins relative to the dental model base.

The above summary is not intended to describe each arrangement or every implementation of the present disclosure. The FIGS. and the detailed description that follow more particularly exemplify various aspects of the present disclosure.

### BRIEF DESCRIPTION OF THE DRAWINGS

FIG. 1 is a perspective view of an example dental pin removal system in accordance with principles of the present disclosure.

FIG. 2 is a bottom perspective view of an example of dental modeling assembly that includes the dental pin removal system shown in FIG. 1 spaced apart from a dental model base and a dowel pin aligned with a pin aperture of the dental model base.

FIG. 3 is a top perspective view of the dental modeling assembly shown in FIG. 2.

FIG. 4 is a top perspective view of the dental modeling assembly shown in FIG. 2 with the dental pin removal system in engagement with the dental model base and the dowel pin fully inserted in the dental model base.

FIG. 5 is a top perspective view of the dental modeling assembly shown in FIG. 4 with the dowel pin partially removed from the dental model base.

FIG. 6 is a side view of the dental modeling assembly shown in FIG. 4 with a dental model mounted to the dental model base and one end of the dowel pin.

FIG. 7 is a side view of the dental modeling assembly shown in FIG. 5 with a portion of the dental model associated with the partially removed dowel pin spaced apart from the dental model base.

### DETAILED DESCRIPTION

A model of a person's teeth (a “dental model”) is commonly mounted to a dental model base for improved ease in handling the dental model. Some types of dental model bases include apertures sized to receive dowel pins (also referred to as dental pins). The pin apertures are defined in a model support surface of the dental model base. The dowel pins extend partially into the aperture and partially into the dental model supported on the dental model base. The dowel pins are typically sized and shaped to have a tight fit within the pin aperture to minimize inadvertent removal of the dowel pin and the dental model to which the dowel pin is connected from the dental model base.

In some dental model base designs, the pin apertures are provided with a size and shape that so closely match the size and shape of the dowel pin that the dowel pin becomes tightly fixed in the pin aperture. In some instances, a great amount of force is required to remove the pin from the dental model base. Removing the dowel pin from the dental model base can be complicated when a portion of the pin is encased within the dental model. Removing the pin from the dental model base by applying force to the dental model can result in damage to the dental model. Even when the dental model is cut at predetermined locations to isolate a tooth model that is aligned with the pin, the connection between the pin and the pin aperture of the dental model base can be too great to overcome by merely pulling on that tooth model.

In some dental model base configurations, a portion of the dowel pin can extend out a rear surface of the dental model base that is opposite from the dental model support surface. Applying force to this free end of the dowel pin in a direction towards the dental model can be problematic if too great a force is applied or the force is applied in such a manner (e.g., an impact force or accelerated movement) that damage to the dental model occurs. The need for controlled, relatively precise movement of the dowel pin can be particularly relevant when working with a waxed up model. The wax connection and/or coatings used with the model can be particularly fragile. In some instances, temporary support members are mounted between multiple teeth of the dental model supported on the dental model base using wax or other material having similar properties to wax. Providing controlled, precise movement of the die relative to the dental model base can help reduce incidence of damage to the wax connections and/or coatings.

The dental pin removal systems and related methods described with reference to the FIGS. below can address these and other issues related to removal of dowel pins from a dental model base.

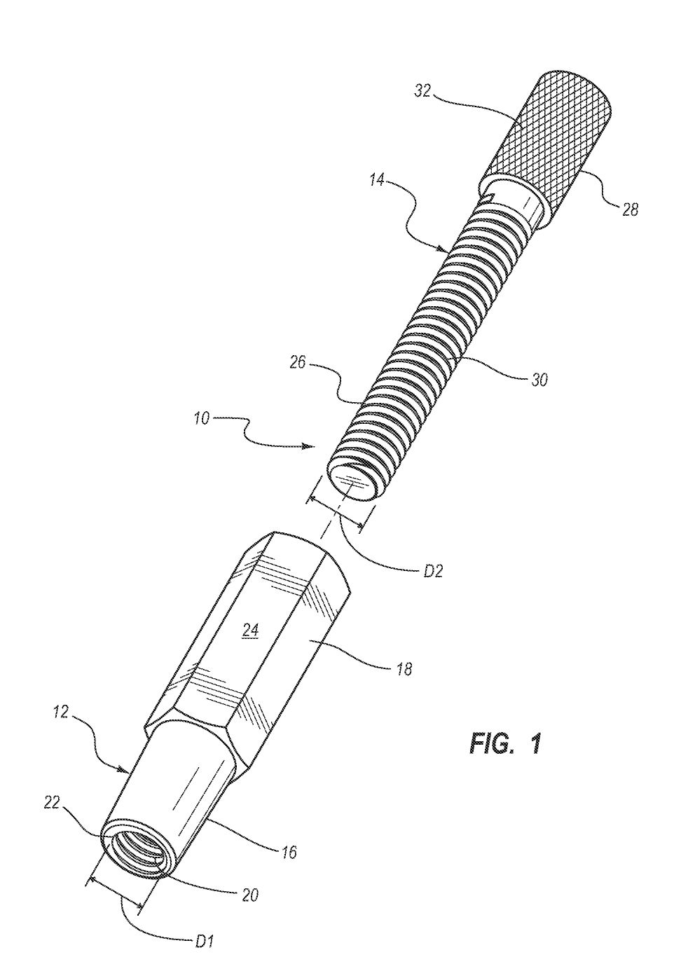

Referring now to FIG. 1, an example dental pin removal system 10 is shown including first and second members 12, 14. The first member 12 includes first and second end portion 16, 18, and a bore 20 defined therein that extends from the first end portion 16 to the second end portion 18. The bore 20 includes an inner set of threads 22. An outer surface 24 of the first member 12 can include a hex feature or other structure that can be used to help rotate the first member 12 using, for example, a wrench.

The second member 14 includes a first end portion 26 and a second end portion 28. An outer set of threads 30 can be formed on an outer surface of the second member 14 along the first end portion 26. A knurled structure can be provided at the second end portion 28 to facilitate grasping and rotating of the second member 14. Other structure can be provided at the second end portion 28 in places or in addition to the knurled portion 32, such as, for example, a hex structure.

The threads 30 of the second member 14 are typically configured to rotatably engage with the threads 22 of the first member 12. The bore 20 has an inner diameter D₁ that is sized similar to an outer diameter D₂ of the second member 14. Typically, the first end portion 26 of the second member 14 is engaged with threads at the second end portion 18 of the first member 12. Further rotation of the second member 14 relative to the first member 12 results in the second member 14 being inserted into the bore 20 of the first member 12.

In one example, the diameters D₁, D₂ are in the range of about 2 mm to about 10 mm, preferably in the range of about 3 mm to about 6 mm, and more preferably in the range of about 3.5 mm to about 4.5 mm. The threads can have any desired pitch angle, depth, and number of threads per unit length.

The first and second members 12, 14 can comprise a metallic material such as, for example, stainless steal. In other arrangements, at least one of the first and second members 12, 14 can comprises a polymeric material. In one example, the first member 12 comprises a different material from a material of the second member 14. The materials selected for use in the first and second members 12, 14 can be particularly well suited for repeated rotation of the first and second members 12, 14 relative to each other at the interface of the threads 22, 30. The materials selected for use in the first and second members 12, 14 can also be particularly well suited for repeated mounting of the first member 12 to the dental model base 102.

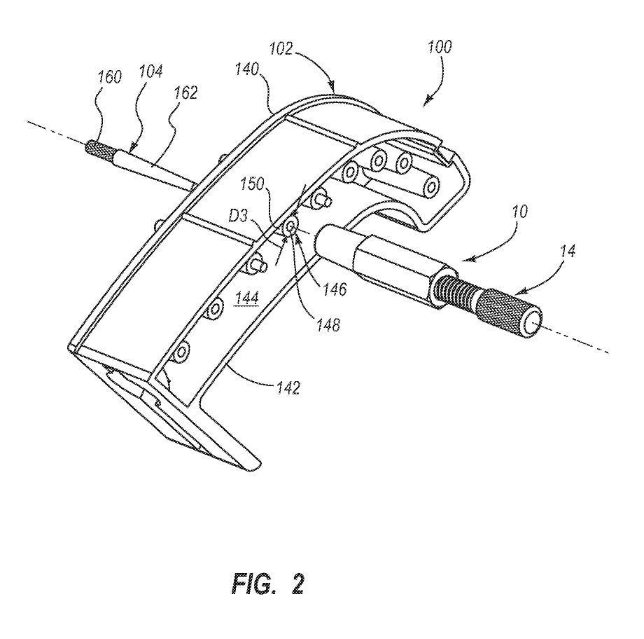

The dental pin removal system 10 can be used as part of a dental modeling assembly 100 as described with reference to FIGS. 2-7. The dental modeling assembly 100 includes a dental model base 102 and at least one dowel pin 104. The dental model base 102 includes a model support surface 140, a wall 142 extending in a direction opposite the model support surface 140 and defining a cavity 144, a plurality of pin protrusions 146 extending into the cavity 144 in a direction opposite the model support surface 140, and a plurality of pin apertures 148 that extend through the model support surface 144 and into the pin protrusions 146.

The pin apertures 148 have a tapered construction with a maximum diameter portion of the aperture positioned at the model support surface 148 and the minimum diameter portion located at an end of the pin protrusion 146 that is spaced furthest from the model support surface 140. The pin protrusion 146 can be shaped to correspond with the tapered shape of the pin aperture. Such a matching shape on an exterior of the pin protrusion 146 provides a constant thickness for the pin protrusion 148 along its length. Providing a constant thickness can be especially useful when the pin protrusion comprises a polymer material. Polymer materials, especially plastics used in an injection molding processes, can have different amounts and rates of shrinkage if the material thickness varies. Maintaining a constant material thickness can provide uniform shrinkage, thereby helping maintain closer size tolerances for the pin aperture 148 defined in the pin protrusions 146.

Each of the pin protrusions 146 includes an outer surface 150 and an outer diameter dimension D3 at an end thereof that is furthest from the model support surface 148 (see FIG. 2). The dimension D3 is typically measured at the end of the pin protrusion 146 that is furthest from the model support surface 140. The dimension D3 is typically substantially the same size or smaller than the inner diameter D₁ of the first number 12 of the pin removal system 10 so that the first member 12 can be mounted to the outer surface 150. Typically, the pin protrusion 146 comprises a material that permits threaded engagement by the inner threads 22 of the first member 12 upon rotation of the first member 12 relative to the pin protrusion 146. This threaded connection releasably mounts the first member 12 to the pin protrusion 46.

The dental model base 102 shown in FIGS. 2-7 is a quadrant dental model base sized to support a portion of a full arc of a person's upper or lower teeth. Many different sizes and shapes of dental model bases 102 can be used in place of the dental model base 102 shown in FIGS. 2-7. Examples of such dental model bases are described in, for example, U.S. Pat. Nos. D576,734; D576,732; D565,186; D481,797; D468,432 and 6,471,513, which patents are incorporated herein in their entirety by this reference.

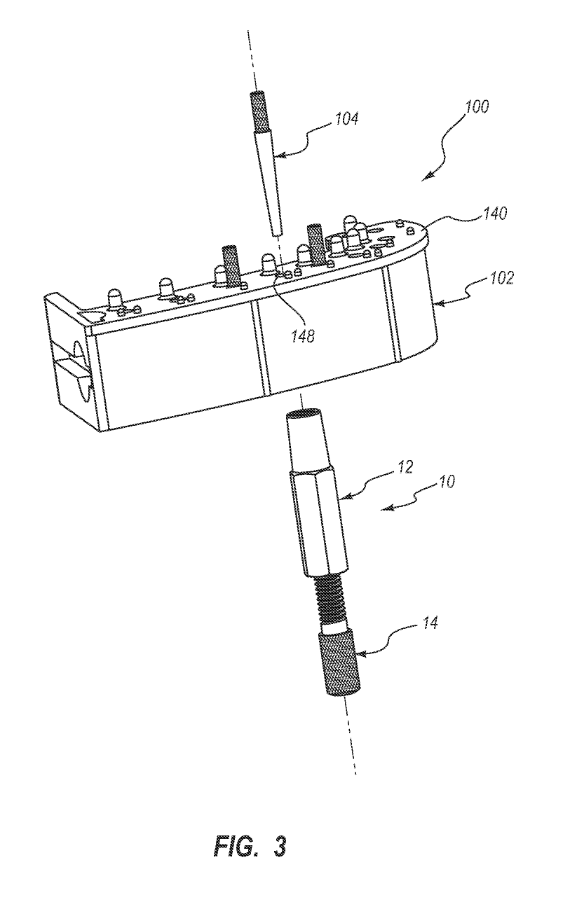

The dowel pins 104 include a first end portion 160 and a second end portion 162. The first end portion is shown having a knurled structure that promotes easy grasping when handling the dowel pin 104 and improved connection of a caste dental model to the dowel pin 104. The second end portion 162 is shown having a tapered construction. The dowel pins 104 are typically sized to extend into the pin aperture 148 through the opening provided on the model support surface 140 (see FIG. 3).

The first member 12 can be mounted to the pin protrusion 146 in alternative ways in other embodiments. For example, rather than a threaded connection via the threads 22 to a smooth outer surface 150 of the pin protrusion 146, a portion of the outer surface 150 can comprise threads, ribs, or other structures for connection to features positioned within the bore 20, such as ribs, threads, recesses, or other protrusion structures. The tapered structure of the outer surface 150 can promote the use of connection features of varying sizes on either the outer surface 150 or within the bore 20 of the first member 12. Further, because the outer surface 150 is tapered, the pin protrusion 146 can be more easily inserted into the bore 20. In some arrangements, the bore 20 does not require a tapered portion at its distal end in order to more easily insert the pin protrusion 146 into the bore 20.

After the first member 12 has been mounted to the pin protrusion 146, the second member 14 can be moved relative to the first member 12 until it engages with an end of the dowel pin 104 that is positioned within the protrusion 146. The use of a threaded interface between the first and second members 12, 14 can promote controlled axial movement of the first member 12 relative to the second member 14 and the dowel pin 104 to gradually move the dowel pin 104 relative to the base 102 in closely controlled, incremental steps. Such incremental, controlled movement of the dowel pin 104 relative to the base 102 can reduce the risk of damage to a dental model that is supported on the dental model base.

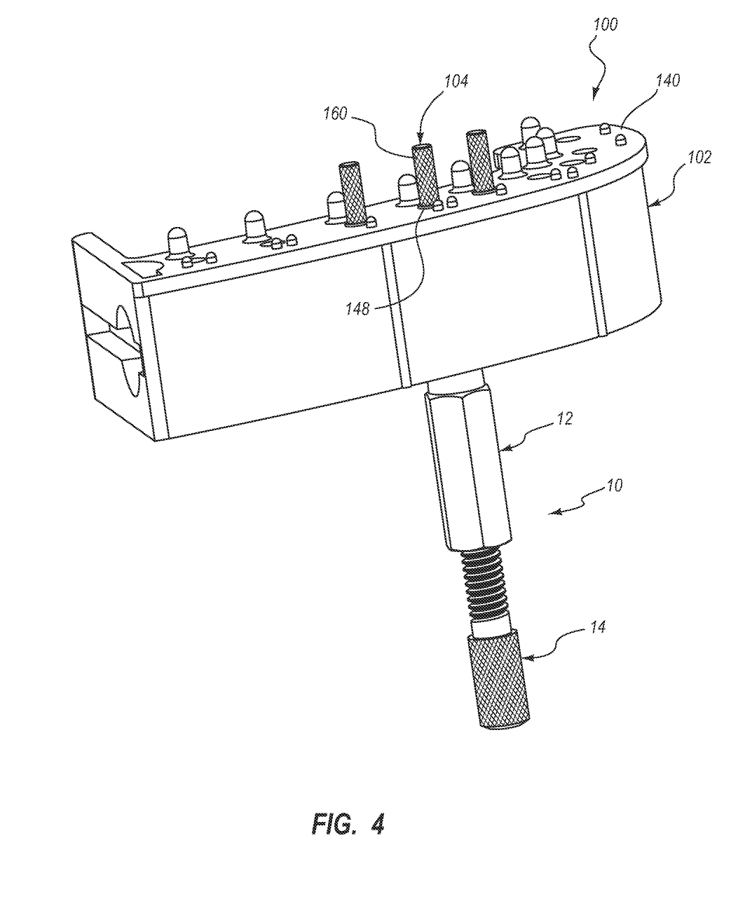

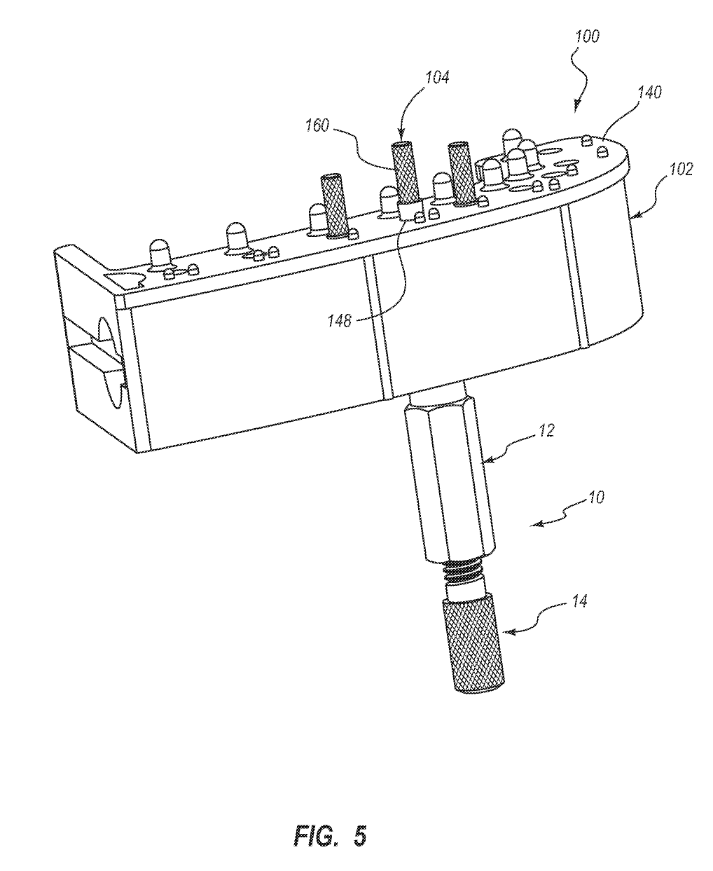

FIG. 4 illustrates a pin 104 fully inserted into the pin aperture 148 of a dental model base 102 and the dental pin removal system 10 mounted to the dental model base 102. FIG. 5 illustrates the dental pin removal system 10 mounted to the dental mode base 102 with the second member 14 axially moved relative to the first member 12 thereby advancing the dowel pin 104 out of the pin aperture 148 in a direction moving away from the model support surface 140.

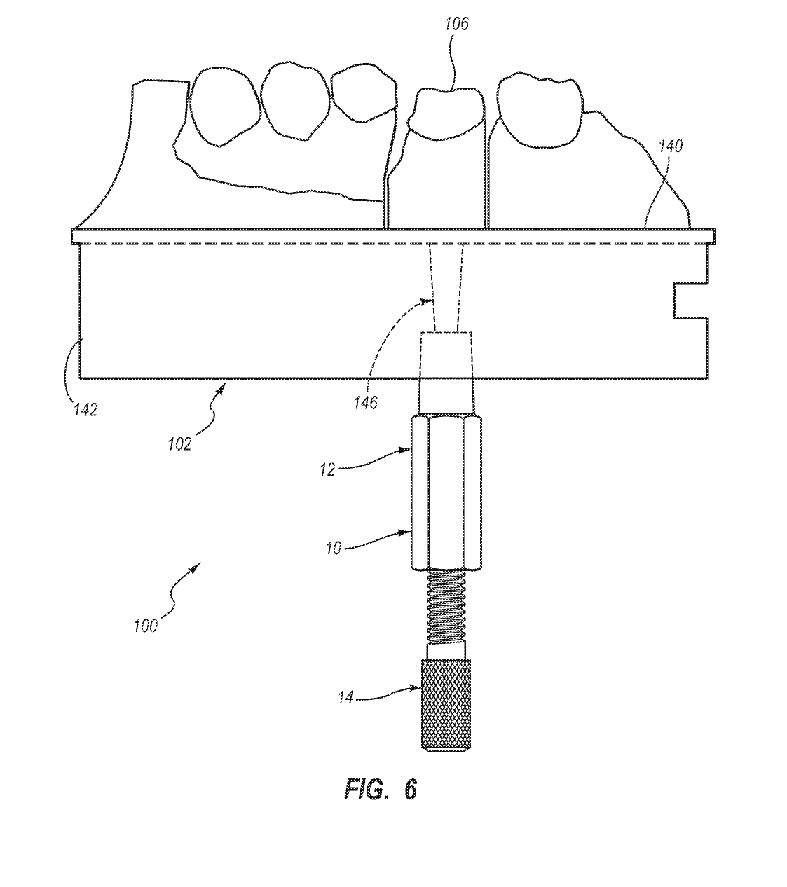

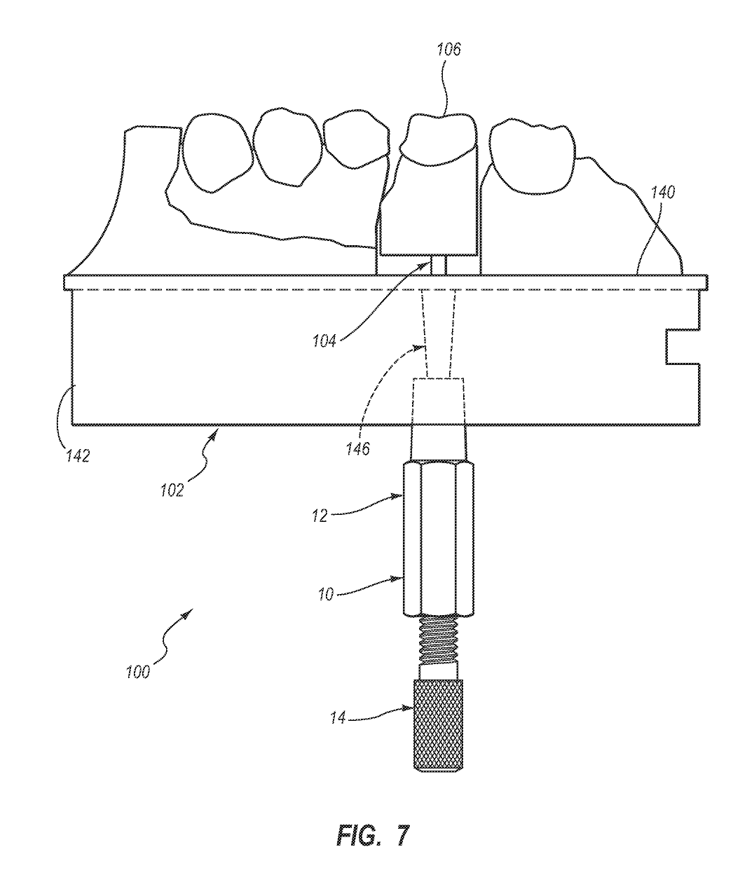

FIGS. 6 and 7 illustrate similar movement of the dowel pin 104 relative to the dental model base 102 but with a dental model 106 mounted to the dowel pin 104. Typically, only a small amount of axial movement of the dowel pin 104 relative to the dental model base 102 is required in order to dislodge the otherwise tight connection between the dowel pin 104 and the dental model base 102. In one example, movement of the dowel pin 104 by engagement of the second member 14 of the dental pin removal system 10 is required in the amount of about 0.1 mm to about 2 mm in order to dislodge the otherwise tight connection between the dowel pin 104 and the dental model base 102.

The above example dental pin removal system 10 is configured for mounting to a pin protrusion 146 to the dental model base 102 and engaging an end of the dowel pin 104 that extends out of the pin protrusion 146. In other embodiments, the second portion 162 of the dowel pin 104 can be maintained entirely within the pin protrusion 146 even when fully inserted in the pin aperture 148. In such an arrangement, the second member 14 of the dental pin removal system 10 can be configured to extend into the pin aperture 148, such as into an open end of the pin protrusion 146 in order to engage the second portion 162 of the dowel pin 104.

In other arrangements, the dental model base 102 can be configured without separate pin protrusions that extend in a direction opposite from the model support surface 140. For example, the dental model base 102 can comprise a base portion that defines the model support surface 140 on one side thereof and has a thickness sufficient to define the pin aperture such as a tapered pin aperture that will fixedly retain the dowel pin 104 therein. In such an embodiment, the dental pin removal system 10 can be configured to mount to other features of the dental model base, such as, for example, the wall 142. Generally, the dental pin removal system 10 is configured to releasably mount to the dental model base 102 in any manner desired regardless of the particular structure of the dental model base while providing access to the second portion 162 of the dowel pin when the dowel pin 104 is mounted within a pin aperture 148.

FIGS. 6 and 7 illustrate a single tooth dental model 106 mounted to the dowel pin 104. In other arrangements, a dental model representing multiple teeth can be mounted to a single dowel pin, such that removal of the dowel pin with the pin removal system can dislodge multiple teeth models from the dental model base.

The dental pin removal system 10 shown and described herein is configured for use in removing a single dowel pin 104 from a dental mode base 102. Other embodiments and configurations are possible for a dental model pin removal system that simultaneously removes multiple dowel pins from a dental model base. For example, a dental pin removal system can comprise at least two sets of first and second members 12, 14 that are assembled as a single pin removal system assembly, wherein the first members 12 are mounted to the dental model base in alignment with at least two separate dowel pins and the second members engage at least two different dowel pins. Since the space between adjacent pin apertures can vary, as shown in at least FIGS. 3 and 4, the spacing between adjacent first members in such an assembly can be adjustable in order to properly align with whatever pin apertures are selected for removal of a dowel pin there from.

The example dental pin removal system 10 described above comprises only two members 12, 14 that interact through removal of a dowel pin 104. Many other configurations are possible for a dental pin removal system for removal of a single dowel pin. For example, more than two members can be assembled together to form a single dental pin removal system. Likewise, the dental pin removal system can comprise a single piece device, wherein, for example, the mere mounting of the dental pin removal system to the dental model base results in engagement with and movement of the dowel pin relative to the dental model base. While a threaded connection is shown between the first and second members 12, 14, other instructions are possible for relative movement between the first and second members 12, 14 such as, for example, sliding engagement, cam systems, linkages, brackets, and other connecting features are possible.

It is noted that not all of the features characterized herein need to be incorporated within a given arrangement, for the arrangement to include improvements according to the present disclosure. Furthermore, since many arrangements of the present disclosure can be made without departing from the spirit and scope of the invention, the invention resides in the claims hereinafter appended.

What is claimed is:

1. A pin removal system configured to remove a pin from a dental model base, the system comprising:
a first member configured to releasably mount to the dental model base; and
a second member movable relative to the first member and into engagement with the pin to move the pin relative to the dental model base.

2. The system of claim 1, wherein the first member includes opposing first and second ends and a bore that extends between the first and second ends, and at least a portion of the second member extends into the bore.

3. The system of claim 1, wherein the first member is mounted to the dental model base with a threaded connection and the second member is mounted to the first member with a threaded connection.

4. The system of claim 1, wherein the dental model base includes a protrusion that at least partially houses the pin, and the first member is mounted to the protrusion.

5. The system of claim 1, wherein the first member includes a plurality of internal threads and the second member includes a plurality of external threads that are sized to engage the threads of the first member.

6. The system of claim 1, wherein the first member remains mounted to the dental model base while the second member moves relative to the first member and into engagement with the pin.

7. The system of claim 1, wherein the second member comprises a knurled portion at a first end thereof, and a threaded portion at a second end thereof, the threaded portion configured to mate with a threaded portion of the first member.

8. A method of removing a pin from a dental model base with a pin removal system, the method including:
releaseably securing the pin removal system to the dental model base; and
engaging the pin with the pin removal system to move the pin relative to the dental model base.

9. The method of claim 9, wherein releaseably securing the pin removal system to the dental model base includes inserting a portion of the dental model base into the pin removal system.

10. The method of claim 9, wherein releaseably securing the pin removal system to the dental model base includes proving a threaded connection between the pin removal system and the dental model base.

11. The method of claim 9, wherein the pin removal system includes at least first and second members that are moveable relative to each other, and releaseably securing the pin removal system to the dental model base includes releaseably securing the first member to the dental model base, and engaging the pin with the pin removal system includes engaging the pin with the second member.

12. The method of claim 11, wherein the first and second members are secured together with a threaded connection, and engaging the pin with the pin removal system includes rotating the second member relative to the first member.

13. A dental modeling assembly, comprising:
a dental model base having a model support surface configured to support a cast stone model of a person's teeth;
a plurality of pins configured for mounting to the dental model base and extending into the cast stone model mounted to the dental model base; and
a pin removal system configured to releaseably mount to the dental model base and engage at least one of the plurality of pins to move the at least one plurality of pins relative to the dental model base.

14. The dental modeling assembly of claim 13, wherein the pin removal system includes first and second members, the first member being configured to releaseably mount to the dental model base, and the second member being configured to move relative to the first member and into engagement with the at least one of the plurality of pins.

15. The dental modeling assembly of claim 14, wherein the first and second members are secured together with a threaded connection.

16. The dental modeling assembly of claim 13, wherein the pin removal system is mounted to the dental model base with a threaded connection.

17. The dental modeling assembly of claim 13, wherein the dental model base includes at least one projection extending in a direction opposite from the model support surface, the projection including a recess sized to receive the one of the plurality of pins, and the pin removal system is releaseably mounted to an exterior surface of the projection.

18. The dental modeling assembly of claim 13, wherein the plurality of pins comprise a tapered portion that extends into the dental model base and a model portion sized to extend into the dental model.
